(19) United States
(12) Patent Application Publication
(10) Pub. No.: US 2025/0264322 A1
(43) Pub. Date: Aug. 21, 2025

(54) MEASUREMENT APPARATUS, MEASUREMENT METHOD, AND MANUFACTURING METHOD

(71) Applicant: CANON KABUSHIKI KAISHA, Tokyo (JP)

(72) Inventor: AYUMU KAMBARA, Tochigi (JP)

(21) Appl. No.: 19/041,753

(22) Filed: Jan. 30, 2025

(30) Foreign Application Priority Data
Feb. 15, 2024 (JP) 2024-020908

(51) Int. Cl. G01B 9/02; G01B 9/02091

(52) U.S. Cl. CPC G01B 9/02039; G01B 9/02083; G01B 9/02091

(57) ABSTRACT

An apparatus that measures a position of a test surface in an optical system, includes a standard unit including a standard surface, an interferometer including a light source that emits test light and reference light and a detector that acquires a first signal and a second signal, an adjustment unit configured to adjust intensity of at least one of the first signal and the second signal, and a computing unit configured to calculate the position of the test surface based on the first signal and the second signal, wherein the first signal is a signal generated by interference between the reference light and standard light that is the test light being reflected from the standard surface, and wherein the second signal is a signal generated by interference between the reference light and measurement light that is the test light being reflected from the test surface.

### BACKGROUND

### Technical Field

The aspect of the embodiments relates to a measurement technique for measuring a position of a test surface in an optical system.

### Description of the Related Art

In an optical system (target optical system) including a plurality of optical elements, placement accuracy of the plurality of optical elements affects optical performance. Therefore, in investigating the cause of poor optical performance, the placement of the optical elements is compared with the designed placement. There is known a method using an interferometer as a method for measuring placement positions of the optical elements in an optical axis direction and surface intervals between a plurality of test surfaces.

Japanese Patent Application Laid-Open No. 2014-102192 discusses an apparatus that guides test light to a target optical system and a standard surface and detects interference caused by reflected light from the target optical system and the standard surface, thereby reducing measurement errors that can occur depending on driving accuracy of a reference surface in an interferometer and effects of environmental changes.

### SUMMARY

According to some exemplary embodiments of the disclosure, an apparatus that measures a position of a test surface in an optical system, includes one or more processors, and a memory storing instructions which, when the instructions are executed by the one or more processors, cause the one or more processors to function as a standard unit including a standard surface, an interferometer including a light source that emits test light and reference light and a detector that acquires a first signal and a second signal, an adjustment unit configured to adjust intensity of at least one of the first signal and the second signal, and a computing unit configured to calculate the position of the test surface based on the first signal and the second signal, wherein the first signal is a signal generated by interference between the reference light and standard light that is the test light being reflected from the standard surface, and wherein the second signal is a signal generated by interference between the reference light and measurement light that is the test light being reflected from the test surface.

Further features of the present exemplary embodiments will become apparent from the following description of exemplary embodiments with reference to the attached drawings.

### BRIEF DESCRIPTION OF THE DRAWINGS

FIG. 1 is a diagram illustrating a configuration of a measurement apparatus according to a first exemplary embodiment.

FIG. 2 is a flowchart illustrating a measurement method according to the first exemplary embodiment.

FIG. 3 is a diagram illustrating a configuration of a measurement apparatus according to a second exemplary embodiment.

FIG. 4 is a flowchart illustrating a measurement method according to the second exemplary embodiment.

FIG. 5 is a diagram illustrating a configuration of a measurement apparatus according to a third exemplary embodiment.

FIG. 6 is a diagram illustrating a configuration of a measurement apparatus according to a fourth exemplary embodiment.

FIG. 7 is a diagram illustrating a configuration of a measurement apparatus according to a fifth exemplary embodiment.

FIG. 8 is a flowchart illustrating a manufacturing method of an optical system using the measurement apparatus according to any one of the exemplary embodiments.

### DESCRIPTION OF THE EMBODIMENTS

Hereinafter, exemplary embodiments of the present disclosure will be described with reference to the drawings. Note that the drawings may be drawn at a scale different from the actual scale for convenience. In the drawings, the same members are denoted by the same reference numerals, and duplicated descriptions thereof will be omitted.

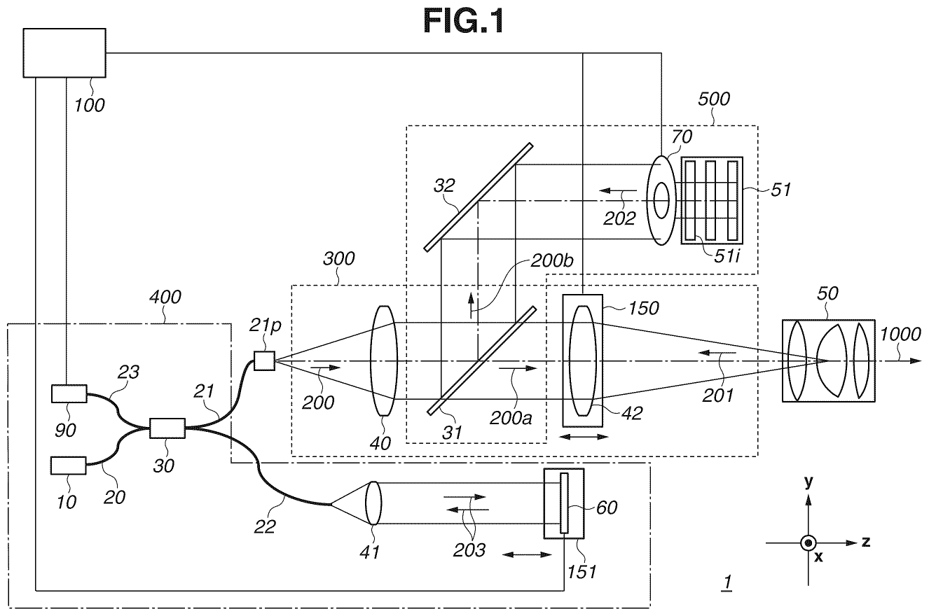

FIG. 1 illustrates a configuration of a measurement apparatus 1 according to a first exemplary embodiment. The measurement apparatus 1 includes a light collection optical system 300, an interferometer 400, a measurement standard unit 500, and a computer (computing unit) 100. A target optical system 50 is an optical system formed by combining a plurality of lenses. The measurement apparatus 1 measures an interval between a plurality of test surfaces of the target optical system 50. In the drawing, only a light ray (principal ray) passing through the center of the optical axis and marginal rays are illustrated, and other light rays are omitted.

The interferometer 400 is a Michelson interferometer that includes a low-coherence light source 10, fibers 20, 21, 22, and 23, a fiber coupler 30, a collimator lens 41, a mirror (reference surface) 60, a detector 90, and a reference stage 151. The low-coherence light source 10 is a broadband light source, such as a super luminescent diode (SLD) light source and an amplified spontaneous emission (ASE) light source. The detector 90 is a photodiode, for example. In the present exemplary embodiment, the low-coherence light source 10, the fibers 20, 21, 22, and 23, and the fiber coupler 30 collectively constitute a light source capable of emitting test light and reference light. The fiber coupler 30 splits the light emitted from the low-coherence light source 10 into test light and reference light. However, the configuration of the light source in the disclosure is not limited thereto.

In order to measure an optical path length in the present exemplary embodiment, the principle of time domain optical coherence tomography (TD-OCT) is used in which the reference stage 151 is driven. However, the disclosure is not limited thereto. Alternatively, the principle of spectral domain (SD)-OCT, which uses a spectroscope instead of the detector 90, or the principle of swept source (SS)-OCT, which uses a wavelength sweeping light source as the light source 10, may be used. In the case of using the principle of SD-OCT or SS-OCT, the movement of a position of the reference surface 60 or the movement of a position of the target optical system 50 may be used in combination as necessary.

The light collection optical system 300 includes a collimator lens 40 and a condenser lens 42. A measurement axis 1000, which is the optical axis of the light collection optical system 300, is parallel to the Z axis in FIG. 1 and substantially coincides with the optical axis of the collimator lens 40. A stage 150 on which the condenser lens 42 is placed can be driven in a Z-axis direction in FIG. 1.

The measurement standard unit 500 includes a beam splitter 31, a mirror 32, an aperture stop (adjustment unit) 70, and a measurement standard 51. The beam splitter 31 is a pellicle beam splitter, for example. The measurement standard 51 includes an array of transparent parallel plates, which is constituted of a total of I surfaces including first to i-th (i=1, 2, . . . , I) surfaces. While in the present exemplary embodiment, a pellicle beam splitter is used as the beam splitter 31, the disclosure is not limited thereto. Alternatively, a cube-type beam splitter or a half mirror may be used. While the measurement standard 51 is constituted of the transparent parallel plates, the measurement standard 51 may be constituted of one mirror or an optical element having a curved surface, or a combination of these. The area of an aperture of the aperture stop 70 is managed by the computer 100.

Light emitted from the low-coherence light source 10 passes through the fiber 20 and is split into test light and reference light by the fiber coupler 30. The reference light is emitted through the fiber 22. The test light passes through the fiber 21 and is emitted divergently from an emission point (fiber end) 21p.

Test light 200 emitted from the emission point 21p of the fiber 21 enters the light collection optical system 300. The test light 200 is collimated by the collimator lens 40 and split by the beam splitter 31 into test light 200a (measurement test light) and test light 200b (standard test light).

The test light 200a having transmitted through the beam splitter 31 is collected by the condenser lens 42 and enters the target optical system 50. The light having entered the target optical system 50 is reflected from each surface in the target optical system 50 to become measurement light 201, and travels backward on an incident light path. More specifically, the measurement light 201 having been reflected from each surface in the target optical system 50 passes through the condenser lens 42 and reaches the beam splitter 31.

The test light 200b having been reflected by the beam splitter 31 is reflected by the mirror 32 and reaches the aperture stop 70. Part of incident light is blocked by the aperture stop 70, and the remaining incident light passes through the aperture stop 70 and enters the measurement standard 51. The aperture stop is an iris stop, for example. In the present exemplary embodiment, intensity of a first interference signal (first interference light) is adjusted using the iris stop as the aperture stop 70, but the disclosure is not limited thereto. The intensity may be adjusted by switching between flat plates with holes different in the area of the aperture, or by blocking part of the light with a flat plate.

Standard light 202, which is the test light 200b reflected from each surface (standard surface 51i) of the measurement standard 51, travels backward on the incident light path. More specifically, the standard light 202 passes through the aperture stop 70, is reflected by the mirror 32, and reaches the beam splitter 31.

The measurement light 201 and the standard light 202 that have reached the beam splitter 31 are recombined, collected by the collimator lens 40, and returned to the incident point (fiber end) 21p. The measurement light 201 and the standard light 202 that have returned to the incident point 21p pass through the fiber 21 again to reach the fiber coupler 30.

Reference light 203 emitted from the fiber 22 is collimated by the collimator lens 41, reflected from the reference surface 60, and passes through the collimator lens 41 and the fiber 22 to reach the fiber coupler 30.

The standard light 202 and the reference light 203 interfere with each other at the fiber coupler 30, and interference light passes through the fiber 23 and is received by the detector 90. At this time, the detector 90 acquires the first interference signal (first interference light). Also, the measurement light 201 and the reference light 203 interfere with each other at the fiber coupler 30, and interference light passes through the fiber 23 and is received by the detector 90. At this time, the detector 90 acquires a second interference signal (second interference light). The acquired first interference signal and second interference signal are sent to the computer 100.

The reference surface 60 is placed on the reference stage 151 that moves in a direction of an arrow in FIG. 1 (Z direction). An optical path length of the reference light (reference optical path length) can be changed by moving the reference stage 151. An envelope of an interference signal has a maximum value when the optical path length of the test light and the optical path length of the reference light are equal. Information on a position of the reference stage 151 (for example, an output value of an encoder or length measurement device, which are not illustrated) is sent to the computer 100.

The computer 100 calculates the position of each of the test surfaces of the target optical system 50 or surface intervals between the plurality of test surfaces based on the interference signal. Specifically, the computer 100 calculates an optical path length (first optical path length) from the low-coherence light source 10 to each surface of the measurement standard 51 based on the first interference signal. Similarly, the computer 100 calculates an optical path length (second optical path length) from the low-coherence light source 10 to each test surface of the target optical system 50 based on the second interference signal. Based on the first interference signal, the computer 100 calculates a positional deviation amount of a test surface that has been acquired simultaneously with the signal of the standard surface among the test surfaces of the target optical system 50. In other words, a test surface for which the intensity of the interference signal is saturated or falls below a detection threshold is excluded. Then, the computer 100 calculates the position of each of the test surfaces based on the positional deviation amount and the second optical path length. At this time, for example, the position of each of the test surfaces of the target optical system 50 (the optical path length from the light source to the test surface) can be calculated by correcting the second optical path length using the positional deviation amount of each of the test surfaces.

The adjustment unit in the present exemplary embodiment is an aperture stop. By changing the area of the aperture of the aperture stop to adjust an amount of the standard light 202 (test light 200b), the intensity of the first interference signal detected by the detector 90 can be adjusted. As a result, even when light source intensity of the interferometer 400 is changed, the intensity of the first interference signal can be adjusted to be within a detection dynamic range (detection range) of the detector 90 and can be acquired simultaneously with the interference signal of each test surface. Thus, the position of each test surface of the target optical system 50 and the surface intervals between the plurality of test surfaces can be measured with high accuracy. The adjustment unit may adjust the intensity of the second interference signal detected by the detector 90 by adjusting the amount of the measurement light 201 (test light 200a). With such a configuration, the same effect can be achieved.

In the measurement standard unit 500 in the present exemplary embodiment, the light emitted from the light source 10 is split by the beam splitter 31 into the test light 200a and the test light 200b. The beam splitter 31 is disposed between the light source 10 and the standard surface on an optical path of the test light. In one embodiment, such a configuration is desirable in reducing influences that the first interference signal and the second interference signal exert on each other.

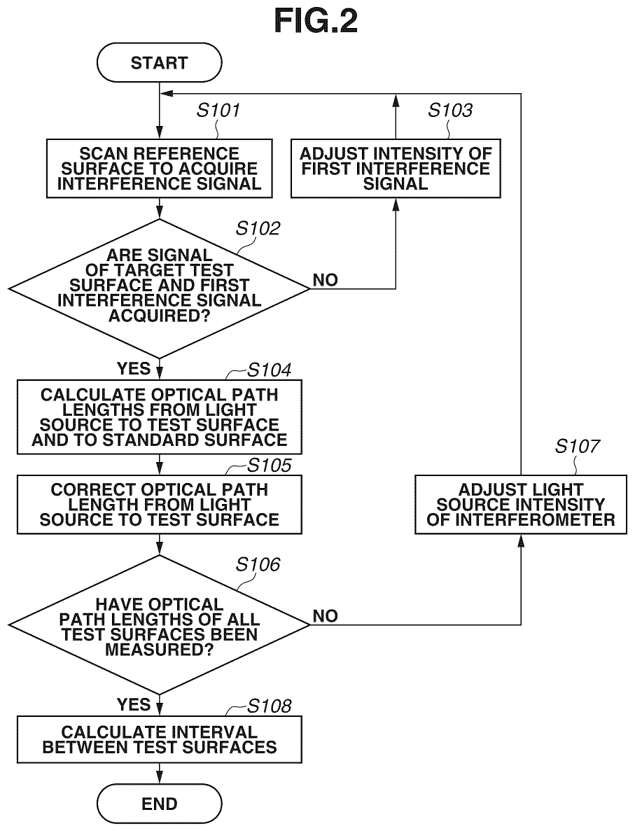

FIG. 2 is a flowchart illustrating a procedure for measuring the position of each of the test surfaces of the target optical system or the surface intervals between the plurality of test surfaces in the first exemplary embodiment.

In step S101, the reference surface 60 of the interferometer 400 is scanned to acquire the first interference signal and the second interference signal. In one embodiment, each of the interference signals may be acquired by moving the reference stage 151 over an entire driving range or may be acquired by moving the reference stage 151 only in a range corresponding to the positions of the target test surface and the standard surface.

In step S102, it is checked whether the signal of the target test surface and the signal of the standard surface have been simultaneously acquired within the dynamic range (detection range) of the detector 90. If acquisition is completed (YES in step S102), the processing proceeds to step S104, and if the acquisition is not completed (NO in step S102), the processing proceeds to step S103.

In step S103, the first interference signal is adjusted using the adjustment unit such that the first interference signal can be acquired within the dynamic range of the detector 90 simultaneously with the signal from the target test surface.

In step S104, the optical path length between each of the test surfaces of the target optical system 50 and the standard surface 51i is calculated based on a measurement position of the reference stage 151 when the envelopes of the first and second interference signals are maximum values.

In step S105, the positional deviation amount of each of the test surfaces of the target optical system 50 is calculated based on the optical path length of the standard surface 51i, and the optical path length of each of the test surfaces is corrected. In a case where the measurement standard 51 includes a plurality of standard surfaces 51i, the positional deviation amount may be calculated based on the optical path length from the light source to each of the standard surfaces 51i and a known interval between the first interference signals of the standard surfaces 51i.

In step S106, it is determined whether the optical path lengths of all the test surfaces have been measured. If the optical path length measurements have been completed (YES in step S106), the processing proceeds to step S108. On the other hand, if the optical path length measurements have not been completed (NO in step S106), the processing proceeds to step S107.

In step S107, intensity of the low-coherence light source 10 is adjusted. A test surface for which it has been determined in step S106 that the optical path length has not been measured is set as a measurement target, and the intensity of the low-coherence light source 10 is adjusted in accordance with the dynamic range of the detector 90.

In step S108, the interval between the test surfaces is calculated based on the optical path length of each of the test surfaces. The optical path lengths of the adjacent test surfaces corrected in step S105 and information on a refractive index between the test surfaces are acquired. The information on the refractive index is design data of the target optical system 50, for example. Then, an optical path length difference is calculated based on the optical path lengths of the adjacent test surfaces. In addition, a group refractive index N_{g}(λ₀) is calculated from the information on the refractive index and a central wavelength λ₀ of the low-coherence light source 10. The group refractive index N_{g}(λ₀) is expressed using Equation 1, where a phase refractive index at the wavelength λ₀ is Nₚ(λ₀), and the wavelength is λ:

$${N}_{g} ( {λ}_{0} ) = {N}_{p} ( {λ}_{0} ) - {λ}_{0} \frac{{dN}_{p} ( {λ}_{0} )}{d λ} \qquad [ Equation 1 ]$$

The surface interval is calculated by dividing the calculated optical path length difference by the group refractive index. If there is air between the test surfaces, the division by the group refractive index may be omitted, and the optical path length difference may be used as the surface interval. This calculation is performed for all the test surfaces.

In conventional measurement apparatuses (and measurement methods), in the case of measuring the position of each of the test surfaces of the target optical system 50 consisting of the plurality of optical elements, it is difficult to acquire the optical path length of each of the test surfaces with high accuracy depending on the state of each of the surfaces (bonding, coating, decentering, or the like) and the state of a light beam at the incident point (fiber end) 21p. In this case, the light source intensity of the interferometer is adjusted, and the interval is calculated using separate measurement data, which is likely to cause an error between measurements. Furthermore, even when a standard surface is provided and the error is corrected, if the interference signal of the standard surface cannot be acquired within the detection range of the detector due to an adjustment of the light source intensity, the error between the measurements cannot be corrected.

Thus, in the measurement apparatus 1 according to the present exemplary embodiment, the intensity of the first interference signal is adjusted using the aperture stop (adjustment unit) 70. With such a configuration, even when the light source intensity of the interferometer 400 is adjusted, the interference signal on the standard surface can be adjusted to be within the detection range of the detector 90. As a result, the position of each of the test surfaces of the target optical system 50 and the surface intervals between the plurality of test surfaces can be measured with high accuracy.

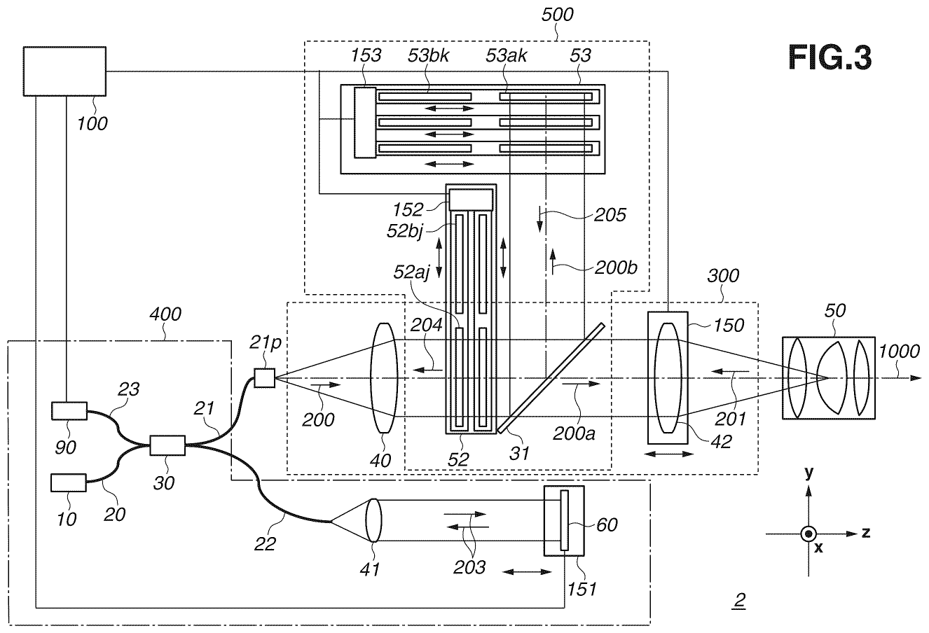

FIG. 3 illustrates a configuration of a measurement apparatus 2 according to a second exemplary embodiment. The measurement apparatus 2 includes a light collection optical system 300, an interferometer 400, a measurement standard unit 500, and a computer (computing unit) 100.

The measurement standard unit 500 includes a beam splitter 31, a measurement standard 52, a measurement standard 53, a stage (adjustment unit) 152, and a stage (adjustment unit) 153. In the drawing, only the light ray (principal ray) passing through the center of the optical axis and marginal rays are illustrated, and other light rays are omitted.

The measurement standard 52 in the present exemplary embodiment includes standard surfaces 52aj (j=1, 2, . . . , J) and standard surfaces 52bj (j=1, 2, . . . , J). The standard surfaces 52aj include an array of transparent parallel plates, which is constituted of a total of J surfaces. The standard surfaces 52bj include an array of surfaces different in reflectance from the standard surfaces 52aj.

With regard to the standard surfaces 52aj and 52bj on the stage 152, the standard surfaces 52aj and 52bj placed on the optical path can be interchanged by moving the stage 152 in a direction perpendicular to the measurement axis 1000.

The measurement standard 53 includes standard surfaces 53ak (k=1, 2, . . . , K) and standard surfaces 53bk (k=1, 2, . . . , K). The standard surfaces 53ak and the standard surfaces 53bk placed on the optical path can be interchanged by moving a stage 153.

As the measurement standard in the present exemplary embodiment, three or more transparent parallel plates may be placed. Alternatively, a single transparent parallel plate may be provided with a reflectance distribution in a stage driving direction. The measurement standard is not limited to a transparent parallel plate, and a plate with a wedge angle may be used. In the case of using the plate with a wedge angle, the amount of standard light 204 (or standard light 205) incident on an incident point 21p can be made different between the front surface and rear surface of the plate. This is desirable in enabling adjustment to a plurality of intensities by a single transparent plate.

While linear stages are used as the stages 152 and 153, the disclosure is not limited to this, and rotary stages may be used instead. Using the rotary stages makes it possible to reduce a space for storing the plurality of transparent parallel plates different in reflectance.

The test light 200 emitted from the emission point 21p is collimated by the collimator lens 40 and reaches the measurement standard 52. Part of the test light 200 is reflected by the standard surface 52aj or the standard surface 52bj to become the standard light 204, and travels backward on the incident light path. More specifically, the test light 200 passes through the collimator lens 40 and returns to the incident point 21p.

The test light 200 having passed through the measurement standard 52 reaches the beam splitter 31 and is split into test light 200a and test light 200b.

The test light 200a having passed through the beam splitter 31 is collected by the condenser lens 42 and enters the target optical system 50. The light having entered the target optical system 50 is reflected from each surface in the target optical system 50 to become the measurement light 201, and travels backward on the incident light path. More specifically, the measurement light 201 passes through the condenser lens 42 and reaches the beam splitter 31.

The test light 200b having been reflected by the beam splitter 31 enters the measurement standard 53. The test light 200b is reflected by the standard surfaces 53ak or the standard surfaces 53bk to become the standard light 205, travels backward on the incident light path, and reaches the beam splitter 31. Then, the measurement light 201 and the standard light 205 that have reached the beam splitter 31 are recombined, pass through the collimator lens 40, and return to the incident point 21p.

The measurement light 201, the standard light 204, and the standard light 205 that have returned to the incident point 21p pass through the fiber 21 again to reach the fiber coupler 30. The measurement light 201, the standard light 204, and the standard light 205 interfere with the reference light 203 at the fiber coupler 30, and the interference light passes through the fiber 23 and is received by the detector 90. Resultant signals (first interference signal and second interference signal) are sent to the computer 100.

The computer 100 calculates the surface intervals in the target optical system 50 based on the interference signals. Specifically, the computer 100 calculates the optical path length (first optical path length) from the low-coherence light source 10 to each of the standard surfaces 52aj, the standard surfaces 52bj, the standard surfaces 53ak, and the standard surfaces 53bk based on the first interference signal. Similarly, the computer 100 calculates the optical path length (second optical path length) from the low-coherence light source 10 to each test surface of the target optical system 50 based on the second interference signal. Based on the first interference signal, the computer 100 calculates a positional deviation amount of a test surface that has been acquired simultaneously with the signal of the standard surface among the test surfaces of the target optical system 50. Then, the computer 100 calculates the surface intervals between the test surfaces based on the positional deviation amount. At this time, the computer 100 can calculate the position of the target optical system 50 by correcting the second optical path length using the positional deviation amount of each of the test surfaces, for example.

The adjustment units in the present exemplary embodiment are the stage 152 and the stage 153 which are driving members. The stage 152 and the stage 153 are used to change the reflectance of the standard surface to adjust the intensity of the first interference signal. More specifically, the stage 152 is used to interchange the standard surfaces 52aj and the standard surfaces 52bj to adjust the amount of the standard light 204 from each of the standard surfaces. Similarly, the stage 153 is used to interchange the standard surfaces 53ak and the standard surfaces 53bk to adjust the amount of the standard light 205 from each of the standard surfaces. As a result, the intensity of the first interference signal can be adjusted such that an interference signal from any one of the plurality of standard surfaces can be acquired within the detection dynamic range (detection range) of the detector 90 even when the light source intensity is changed. Accordingly, the surface intervals in the target optical system 50 can be measured with high accuracy.

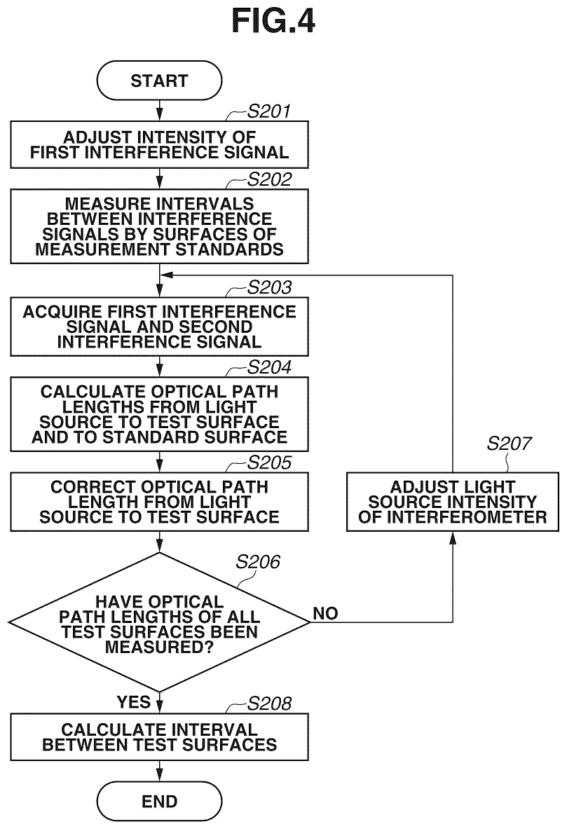

FIG. 4 is a flowchart illustrating a procedure for measuring the surface intervals in the target optical system according to the second exemplary embodiment.

In step S201, the intensity of the first interference signal is adjusted such that an interference signal of any one of the plurality of standard surfaces can be acquired within the detection range even when the light source intensity is changed. In the present exemplary embodiment, in step S201, the intensity of the first interference signal is adjusted by interchanging the standard surfaces different in reflectance using the stage 152 or the stage 153.

In step S202, the intervals between the interference signals are measured by the surfaces of the measurement standard 52 and the measurement standard 53. Step S202 may be performed using a length measurement tool different from the measurement apparatus 2.

In step S203, a reference surface 60 of the interferometer 400 is scanned to acquire a first interference signal and a second interference signal.

In step S204, the optical path length to each surface in the target optical system 50 and the optical path length to each of the standard surfaces 52aj, 52bj, 53ak, and 53bk are calculated.

In the present exemplary embodiment, the optical path length is calculated based on the measurement position of the reference stage 151 when the envelopes of the first interference signal and the second interference signal exhibit maximum values.

In step S205, the amount of positional deviation of each of the test surfaces in the target optical system 50 is calculated based on the optical path length of the standard surface, and the optical path length of the test surface is corrected. The amount of positional deviation of each test surface is calculated based on the optical path lengths from the light source to the standard surfaces 52aj, 52bj, 53ak, and 53bk, and the intervals between the interference signals from the surfaces of the measurement standard 52 and the measurement standard 53 obtained in step S202.

In step S206, it is determined whether the optical path lengths of all the test surfaces have been measured. If the optical path length measurements have been completed (YES in step S206), the processing proceeds to step S208. On the other hand, if the measurements have not been completed (NO in step S206), the processing proceeds to step S207.

In step S207, intensity of the low-coherence light source 10 of the interferometer 400 is adjusted.

A test surface for which it has been determined in step S206 that the optical path length has not been measured is set as a measurement target, and the intensity of the low-coherence light source 10 is adjusted in accordance with the dynamic range of the detector 90.

In step S208, the interval between the test surfaces is calculated based on the optical path length of each of the test surfaces.

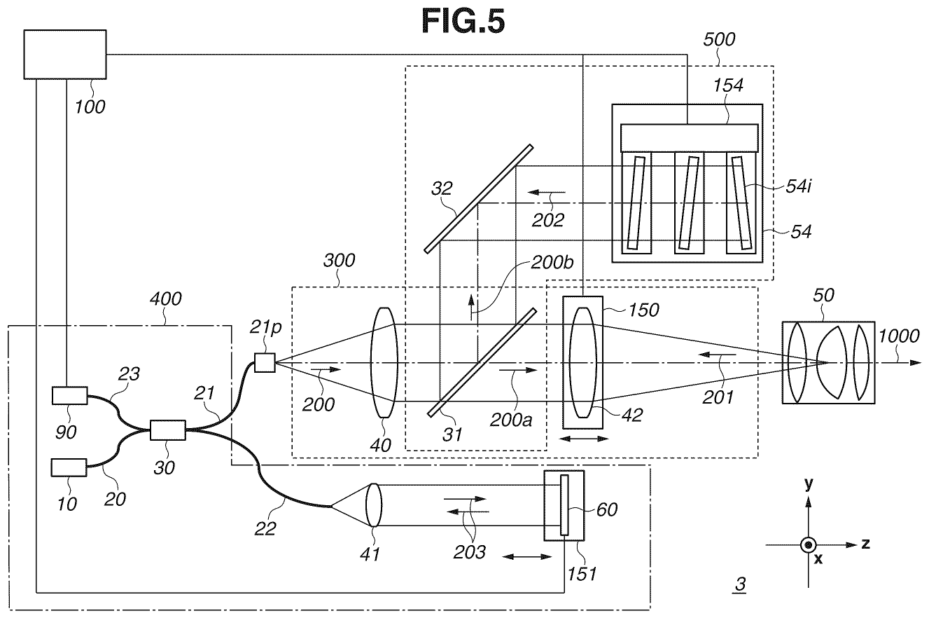

FIG. 5 illustrates a configuration of a measurement apparatus 3 according to a third exemplary embodiment. The measurement apparatus 3 includes a light collection optical system 300, an interferometer 400, a measurement standard unit 500, and a computer (computing unit) 100.

The measurement standard unit 500 includes a beam splitter 31, a mirror 32, a measurement standard 54, and a stage (adjustment unit) 154. The measurement standard 54 includes an array of transparent parallel plates, which is constituted of a total of I standard surfaces 54i including first to i-th (i=1, 2, . . . , I) surfaces. The stage 154 is capable of adjusting an angle of each of the transparent parallel plates. In the drawing, only the light ray (principal ray) passing through the center of the optical axis and marginal rays are illustrated, and other light rays are omitted.

Test light 200 emitted from an emission point 21p is collimated by a collimator lens 40, reaches the beam splitter 31, and is split into test light 200a and test light 200b.

The test light 200b having been reflected by the beam splitter 31 is reflected by the mirror 32 and enters the measurement standard 54. Standard light 202, which is the test light 200b reflected by the standard surfaces 54i, travels backward on the incident light path and reaches the beam splitter 31.

The standard light 202 having reached the beam splitter 31 is recombined with measurement light 201, passes through the collimator lens 40, and returns to the incident point 21p.

The adjustment unit in the present exemplary embodiment is the stage 154 which is a driving member. The inclination of each of the standard surfaces 54i is adjusted using the stage 154 to adjust the amount of the standard light 202 incident on the incident point 21p from each of the standard surfaces. As a result, the intensity of a first interference signal can be adjusted such that an interference signal from any one of the plurality of standard surfaces 54i can be acquired within the detection dynamic range (detection range) of a detector 90 even when the light source intensity is changed. Accordingly, the surface intervals in the target optical system 50 can be measured with high accuracy.

The method for adjusting the inclination of each of the standard surfaces 54i is not limited to this. Alternatively, the inclination of the entire measurement standard 54 may be adjusted, or the angle of the beam splitter 31 or the mirror 32 may be adjusted. The inclination angle of the stage 154 is managed by the computer 100.

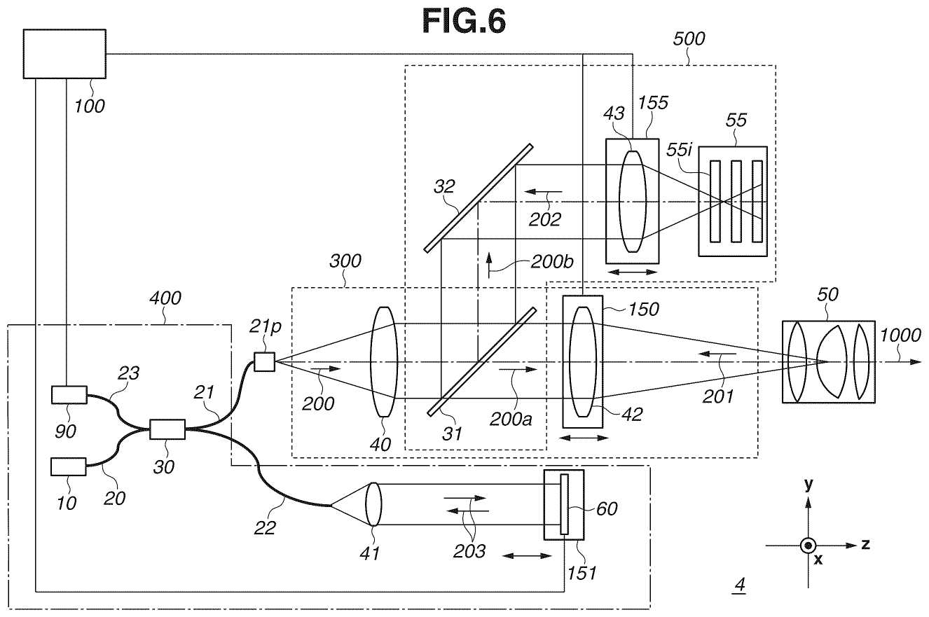

FIG. 6 illustrates a configuration of a measurement apparatus 4 according to a fourth exemplary embodiment. The measurement apparatus 4 includes a light collection optical system 300, an interferometer 400, a measurement standard unit 500, and a computer (computing unit) 100. In the drawing, only the light ray (principal ray) passing through the center of the optical axis and marginal rays are illustrated, and other light rays are omitted.

The measurement standard unit 500 includes a beam splitter 31, a mirror 32, a measurement standard 55, a condenser lens 43, and a stage (adjustment unit) 155 that can be driven in a Z-axis direction in the drawing.

The measurement standard 55 includes an array of transparent parallel plates, which is constituted of a total of I standard surfaces 55i including first to i-th (i=1, 2, . . . , I) surfaces. The condenser lens 43 is disposed on the stage 155. However, the disclosure is not limited to this configuration. The same effects can be achieved by placing the measurement standard 55 on the stage 155 and moving the measurement standard 55 to change a focusing position of the condenser lens 43 on the measurement standard 55. Furthermore, in order to easily acquire the signal intensity on the plurality of standard surfaces, in one embodiment, the condenser lens 43 is a lens with a large focal depth and a long focal length.

Test light 200 emitted from an emission point 21p is collimated by a collimator lens 40, reaches the beam splitter 31, and is split into test light 200a and test light 200b.

The test light 200b having been reflected by the beam splitter 31 is reflected by the mirror 32 and collected by the condenser lens 43. The test light 200b collected by the condenser lens 43 enters the measurement standard 55. Standard light 202, which is the test light 200b having been reflected from the standard surfaces 55i, travels backward on the incident light path and reaches the beam splitter 31. The standard light 202 having reached the beam splitter 31 is recombined with measurement light 201, passes through the collimator lens 40, and returns to the incident point 21p.

The adjustment unit in the present exemplary embodiment is the stage 155 which is a driving member. The amount of the standard light 202 incident on the incident point 21p from each of the standard surfaces is adjusted by adjusting the focusing position of the condenser lens 43 using the stage 155. As a result, the intensity of a first interference signal can be adjusted such that an interference signal corresponding to any one of the plurality of standard surfaces can be acquired within the detection dynamic range (detection range) of a detector 90 even when the light source intensity is changed. Accordingly, the surface intervals in the target optical system 50 can be measured with high accuracy.

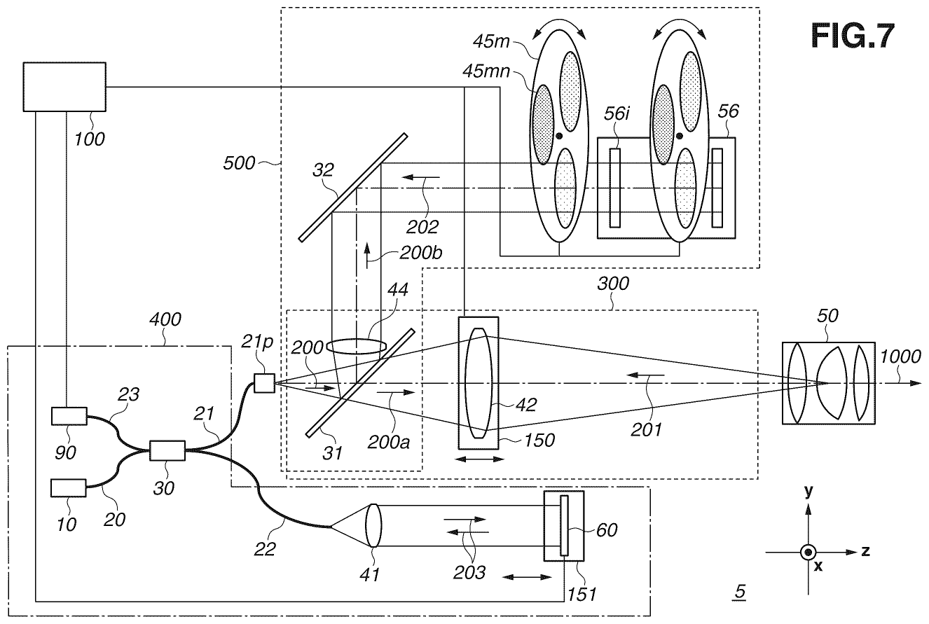

FIG. 7 illustrates a configuration of a measurement apparatus 5 according to a fifth exemplary embodiment. The measurement apparatus 5 includes a light collection optical system 300, an interferometer 400, a measurement standard unit 500, and a computer (computing unit) 100. In the drawing, only the light ray (principal ray) passing through the center of the optical axis and marginal rays are illustrated, and other light rays are omitted.

The measurement standard unit 500 includes a beam splitter 31, a collimator lens 44, a mirror 32, a measurement standard 56, rotation stages (adjustment units) 45m, and neutral density filters 45mn.

The measurement standard 56 includes an array of transparent parallel plates, which is constituted of a total of I standard surfaces 56i including first to i-th (i=1, 2, . . . , I) surfaces. The rotation stages 45m are placed in front of the corresponding transparent parallel plates. There are provided at least a total of M rotation stages 45m of first to m-th (m=1, 2, . . . , M) stages, which is the same number as the number of the transparent parallel plates.

The neutral density filters 45mn are placed on the rotation stages 45m. Any one of a total of N neutral density filters 45mn including first to n-th (n=1, 2, . . . , N) filters different in transmittance is selected and disposed in the optical path of test light 200b (standard light 202). As the neutral density filter 45mn, an absorptive neutral density (ND) filter or a reflective ND filter can be used. Alternatively, if a low-coherence light source 10 is polarized, a polarizing element may be used as the neutral density filter 45mn. A variable ND filter divided into regions different in optical density in a circular shape may be used, or a variable ND filter whose optical density changes continuously in a direction of rotation may be used.

Test light 200 emitted from an emission point 21p reaches the beam splitter 31 and is split into test light 200a and test light 200b.

The test light 200a having passed through the beam splitter 31 is collected by a condenser lens 42 and enters a target optical system 50. The light having entered the target optical system 50 is reflected from each surface in the target optical system 50 to become measurement light 201, and travels backward on the incident light path. More specifically, the measurement light 201 having been reflected from each surface in the target optical system 50 passes through the condenser lens 42 and reaches the beam splitter 31.

The test light 200b having been reflected by the beam splitter 31 is collimated by the collimator lens 44 and reflected by the mirror 32. Then, the test light 200b is reduced in intensity through one of the neutral density filters 45mn placed on the rotation stages 45m and enters the standard surfaces 56i of the measurement standard 56. The test light 200b passes through the neutral density filters 45mn and the transparent parallel plates, is reflected by each of the standard surfaces 56i to become the standard light 202, and travels backward on the incident light path. More specifically, the standard light 202, which is the test light 200b having been reflected from each of the standard surfaces 56i, is reflected by the mirror 32 and reaches the beam splitter 31.

The measurement light 201 and the standard light 202 that have reached the beam splitter 31 are recombined and returned to the incident point 21p.

The adjustment units in the present exemplary embodiment are the rotation stages 45m which are rotation members. The amount of the standard light 202 from each standard surface is adjusted by interchanging the neutral density filters 45mn using the rotation stages 45m. As a result, the intensity of a first interference signal can be adjusted such that an interference signal corresponding to any one of the plurality of standard surfaces 56i can be acquired within the detection dynamic range (detection range) of a detector 90 even when the light source intensity is changed. Accordingly, the surface intervals in the target optical system 50 can be measured with high accuracy.

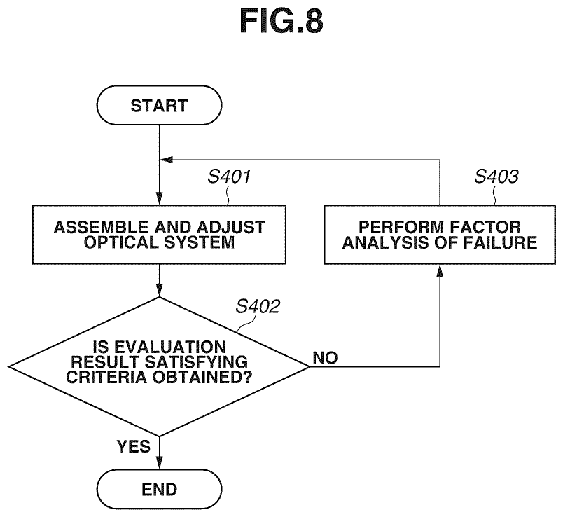

FIG. 8 is a flowchart of a manufacturing method of an optical system according to a sixth exemplary embodiment.

The surface intervals measured using any one of the measurement apparatuses 1 to 5 described in the first to fifth exemplary embodiments can be fed back to the manufacturing method of the optical system (target optical system 50).

First, in step S401, a manufacturer assembles an optical system using a plurality of optical elements (lenses and the like), and adjusts positions of the optical elements.

In step S402, the manufacturer evaluates accuracy and performance of the assembled and adjusted optical system. If an evaluation result satisfying a criteria is not obtained (NO in step S402), the processing proceeds to step S403. In step S403, a factor analysis of failure to satisfy the criteria is performed. One subject of the analysis is the surface intervals between the optical elements. Any one of the measurement apparatuses 1 to 5 can be used to measure the surface intervals. On the other hand, if an evaluation result satisfying the criteria is obtained (YES in step S402), manufacture of the optical system using the manufacturing method is ended.

A result of measurement of the surface intervals can be utilized not only for the factor analysis of failure in step S403, but also for adjustment of the positions of the optical elements in step S401. More specifically, the surface intervals between the plurality of optical elements of the optical system can be measured using any one of the measurement apparatuses 1 to 5, and the adjustment of the positions of the optical elements can be performed using the measurement result.

While exemplary embodiments of the disclosure have been described above, the disclosure is not limited to these exemplary embodiments. Various combinations, modifications, and changes are possible within the scope of the gist of the disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the exemplary embodiments of the disclosure has been described above, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-020908, filed Feb. 15, 2024, which is hereby incorporated by reference herein in its entirety.

What is claimed is:

1. An apparatus that measures a position of a test surface in an optical system, the apparatus comprising:
one or more processors; and
a memory storing instructions which, when the instructions are executed by the one or more processors, cause the one or more processors to function as:
a standard unit including a standard surface;
an interferometer including a light source that emits test light and reference light and a detector that acquires a first signal and a second signal;
an adjustment unit configured to adjust intensity of at least one of the first signal and the second signal; and
a computing unit configured to calculate the position of the test surface based on the first signal and the second signal,
wherein the first signal is a signal generated by interference between the reference light and standard light that is the test light being reflected from the standard surface, and
wherein the second signal is a signal generated by interference between the reference light and measurement light that is the test light being reflected from the test surface.

2. The apparatus according to claim 1,
wherein the computing unit acquires a first optical path length from the light source to the standard surface based on the first signal,
wherein the computing unit acquires a second optical path length from the light source to the test surface based on the second signal, and
wherein the computing unit calculates the position of the test surface based on the first optical path length and the second optical path length.

3. The apparatus according to claim 1, wherein the standard unit includes a plurality of standard surfaces.

4. The apparatus according to claim 3, wherein the computing unit calculates a position of each of the plurality of standard surfaces based on the first signal, and calculates the position of the standard surface based on the position and the second signal.

5. The apparatus according to claim 1, wherein the adjustment unit adjusts the intensity of the first signal based on the intensity of the second signal or a detection range of the detector.

6. The apparatus according to claim 1, wherein the adjustment unit is an aperture stop.

7. The apparatus according to claim 1, wherein the adjustment unit is a driving member configured to change an inclination of the standard surface.

8. The apparatus according to claim 1, wherein the adjustment unit includes:
a condenser lens configured to collect the test light onto the standard surface; and
a driving member configured to drive the condenser lens.

9. The apparatus according to claim 1,
wherein the standard unit includes a plurality of standard surfaces different in reflectance, and
wherein the adjustment unit is a driving member configured to drive the plurality of standard surfaces.

10. The apparatus according to claim 1, wherein the adjustment unit is a neutral density filter.

11. The apparatus according to claim 1,
wherein the standard unit includes an element configured to split the test light, and
wherein the optical element is disposed between the standard surface and the detector on an optical path of the standard light.

12. A method for measuring a position of a test surface in an optical system, the method comprising:
emitting test light and reference light from a light source and acquiring a first signal and a second signal;
adjusting intensity of at least one of the first signal and the second signal; and
calculating the position of the test surface based on the first signal and the second signal,
wherein the first signal is a signal generated by interference between the reference light and standard light that is the test light being reflected from a standard surface, and
wherein the second signal is a signal generated by interference between the reference light and measurement light that is the test light being reflected from the test surface.

13. The method according to claim 12, further comprising:
acquiring a first optical path length from the light source to the standard surface based on the first signal;
acquiring a second optical path length from the light source to the test surface based on the second signal; and
calculating the position of the test surface based on the first optical path length and the second optical path length.

14. The method according to claim 12, wherein the adjusting adjusts the intensity of the first signal based on the intensity of the second signal or a detection range of a detector.

15. The method according to claim 12, wherein the adjusting includes changing an inclination of the standard surface.

16. The method according to claim 12, wherein the adjusting includes:
collecting the test light onto the standard surface by a condense lens; and
driving the condenser lens.

17. The method according to claim 12, wherein the adjusting includes driving a plurality of standard surfaces different in reflectance.

18. A manufacturing method comprising:
measuring a position of a test surface in an optical system by using the method according to claim 12; and
adjusting the optical system using a result of measurement of the position of the test surface.

19. The manufacturing method according to claim 18, further comprising:
acquiring a first optical path length from the light source to the standard surface based on the first signal;
acquiring a second optical path length from the light source to the test surface based on the second signal; and
calculating the position of the test surface based on the first optical path length and the second optical path length.

20. The manufacturing method according to claim 18, further comprising adjusting the intensity of the first signal based on the intensity of the second signal or a detection range of a detector.
